(19) United States
(12) Patent Application Publication
(10) Pub. No.: US 2026/0211632 A1
(43) Pub. Date: Jul. 23, 2026

(54) MIND GRAPH-BASED CODE GENERATION USING LARGE LANGUAGE MODEL

(71) Applicant: SAP SE, Walldorf (DE)

(72) Inventors: Xin Ye, Beijing (CN); Zhi-feng Deng, Beijing (CN); Yang Yang, Beijing (CN); Lei Huang, Beijing (CN); Wei-quan Zhou, Beijing (CN)

(21) Appl. No.: 19/081,286

(22) Filed: Mar. 17, 2025

(30) Foreign Application Priority Data
Jan. 22, 2025 (WO) PCT/CN2025/073857

(51) Int. Cl. G06F 8/34; G06F 8/33; G06F 8/35

(52) U.S. Cl. CPC G06F 8/34; G06F 8/33; G06F 8/35

(57) ABSTRACT

In an example embodiment, a novel data structure called a “mind graph” is introduced, which defines all of the different possible combinations of tasks within a software project, as well as the potential flows among the tasks. This mind graph is then passed as input, along with a prompt generated by natural language input from a user, to an LLM. The LLM uses the mind graph and the prompt to generate an execution plan which defines which tasks from the mind graph will be generated and the path the flow takes though those tasks. This execution plan is then presented to the user in a graphical user interface that allows the user to edit the execution plan. The edited execution plan is then submitted to the LLM to generate the actual code for each of the tasks. This code is again presented to the user to accept, or modify, the code for each of these tasks.

### CLAIM OF PRIORITY

The present patent application claims the priority benefit of the filing date of PCT/CN2025/073857 filed Jan., 22, 2025, the entire content of which is incorporated herein by reference.

### TECHNICAL FIELD

This document generally relates to computer systems. More specifically, this document relates to mind graph-based code generation using a large language model.

### BACKGROUND

A large language model (LLM) refers to an artificial intelligence (AI) system that has been trained on an extensive dataset to understand and generate human language. These models are designed to process and comprehend natural language in a way that allows them to answer questions, engage in conversations, generate text, and perform various language-related tasks.

### BRIEF DESCRIPTION OF DRAWINGS

The present disclosure is illustrated by way of example and not limitation in the figures of the accompanying drawings, in which like references indicate similar elements.

FIG. 1 is a diagram illustrating examples of mind graphs, in accordance with an example embodiment.

FIG. 2 is an example execution plan, depicted in graphical form.

FIGS. 3-5 are diagrams illustrating an example graphical user interface at different times during LLM generation, in accordance with an example embodiment.

FIG. 6 is a block diagram illustrating a system for mind graph-based code generation, in accordance with an example embodiment.

FIG. 7 is a flow diagram illustrating a method for mind graph-based code generation, in accordance with an example embodiment.

FIG. 8 is a block diagram illustrating an architecture of software for embedding searches, which can be installed on any one or more devices.

FIG. 9 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

The recent advancements in Artificial Intelligence (AI) and Natural Language Processing (NLP) gave rise to the development of different code generation tools using Large Language Models (LLMs). Such tools come in different variations: while some of them can be integrated into the development environment to make real-time code suggestions (e.g., the Copilot IDE plugin by GitHub, Inc. of San Francisco, CA), others provide a chat interface (e.g., ChatGPT by OpenAI, Inc. of San Francisco, CA) that the developers can interact with. These tools have the potential to increase the productivity of developers by accelerating the development process and helping the developers with different features of a programming language, even if they have not used the language before.

While code generation has proven adequate for simple tasks, as integration scenarios become more complex, the quality of generated code tends to decrease, especially when proprietary domain knowledge is required within a more complex user requirement.

Cloud computing can be described as Internet-based computing that provides shared computer processing resources, and data to computers and other devices on demand. Users can establish respective sessions, during which processing resources, and bandwidth are consumed. During a session, for example, a user is provided on-demand access to a shared pool of configurable computing resources (e.g., computer networks, servers, storage, applications, and services). The computing resources can be provisioned and released (e.g., scaled) to meet user demand. An example cloud platform includes SAP Cloud Application Platform (CAP), from SAP SE of Walldorf, Germany. A cloud platform may run a data model infrastructure, where data models can be created and run.

One example of such a data model infrastructure is Core Data Services (CDS) from SAP SE of Walldorf, Germany. CDS enables service definitions and data models to be declaratively captured in plain object notations. CDS models are typically written in CDS language, and when compiled are typically stored in Javascript Object Notation (JSON) files, which comply with a standard notation, such as core schema notation (CSN). These models are compiled and run on a server, which can then handle requests for the application defined by the model(s) as they come in.

A common architecture in cloud platforms includes services (also referred to as microservices), which have gained popularity in service-oriented architectures (SOAs). In such SOAs, applications are composed of multiple, independent services. The services are deployed and managed within the cloud platform and run on top of a cloud infrastructure. In some examples, service-based applications can be created and/or extended using an application programming framework. In an example embodiment, the software servers created implement the services.

CAP provides a framework to interpret domain language, in which data models are defined in a declarative way (i.e., not programmatically).

A CAP project includes the creation of the data models as well as potentially the creation of related objects and information, such as CAP data, CAP logic, CAP tests, etc. Because of this complexity, using LLMs to generate all of this information for a CAP project using a single LLM prompt can be challenging and results are often sub-par. These disparate pieces of information that need to be generated may be called “tasks.” There may be many such tasks within a single CAP project.

In an example embodiment, a novel data structure called a “mind graph” is introduced, which defines all of the different possible combinations of tasks within a CAP project, as well as the potential flows among the tasks. This mind graph is then passed as input, along with a prompt generated by natural language input from a user, to an LLM. The LLM uses the mind graph and the prompt to generate an execution plan which defines which tasks from the mind graph will be generated and the path the flow takes though those tasks. This execution plan is then presented to the user in a graphical user interface that allows the user to edit the execution plan. The edited execution plan is then submitted to the LLM to generate the actual code for each of the tasks. This code is again presented to the user to accept, or modify, the code for each of these tasks.

The mind graph data structure contains a series of nodes, including a starting node, task nodes, and an end node. Tasks are represented by task nodes. Edges between the nodes represent possible paths from task to task. The intent of the mind graph data structure is to represent all the possible tasks that can be performed within a project (such as a CAP project) and all the possible paths among those possible tasks.

The mind graph data structure for a given CAP project may be one that is predefined or created from scratch. For predefined mind graph data structures, there may be different mind graph data structures for different types of CAP projects and the mind graph data structure for the particular type of CAP project being created may be selected and used. Alternatively, the user or an administrator can create a mind graph data structure from scratch for a particular CAP project.

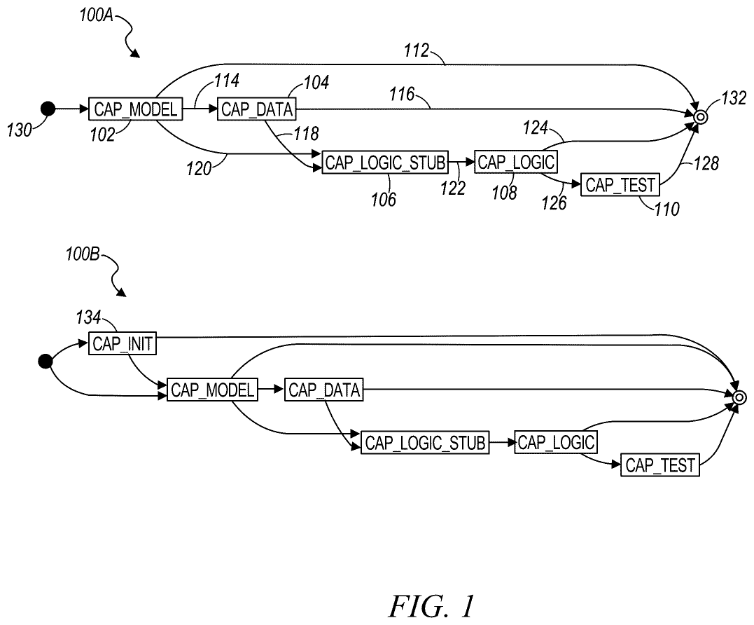

FIG. 1 is a diagram illustrating examples of mind graphs, in accordance with an example embodiment. Here, mind graph 100A is a predefined mind graph based on a type of project while mind graph 100B is created from scratch.

Mind graph 100A includes task nodes 102, 104, 106, 108, and 110. Mind graph 100A also includes edges 112, 114, 116, 118, 120, 122, 124, 126, and 128 among the task nodes 102, 104, 106, 108, and 110 as well as a start node 130 and an end node 132. Each task node corresponds to a different potential task in the project. Each edge 112, 114, 116, 118, 120, 122, 124, and 126 is directional, indicating the flow direction. Notably, the mind graph 100A describes various possible paths among the possible tasks. Thus, for example, there is one path that goes from the start node 130 to task node 102 to task node 104 to end node 132. If this path is executed, then only two tasks will have code generated: the task corresponding to task node 102 and the task corresponding to task node 104. If that path is selected, no other tasks will have code generated. Alternatively, if a different path is executed, such as the path that goes from the start node 130 to task node 102 to task node 106 to task node 108 to the end node 132, then different tasks will have their code generated. Thus, the mind graph 100A indicates different possible combinations of paths and task nodes that could be executed.

Mind graph 100B is similar to mind graph 100A, except with an additional task node 134, and of course additional edges as well.

A user-supplied natural language code generation request can be input by the user and supplied to the LLM in a prompt along with the mind graph for the project. The natural language code generation request specifies the user's requirements for the project. For example, the user may supply the following natural language code generation request for the CAP project: Generate a capex application using FE UI, with properties name, description, total cost, and criticality, set the criticality to 1 when the total cost is higher than 1000, otherwise set to 2.

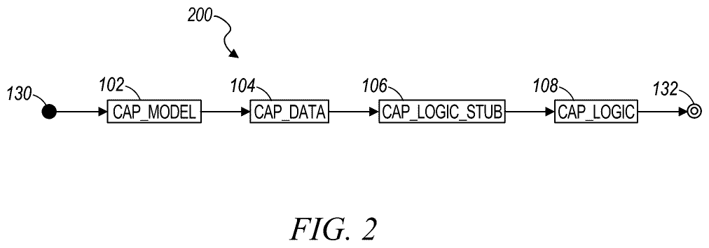

The combination of the user-supplied natural language code generation request and the corresponding mind graph can be fed to the LLM in a prompt that also requests that the LLM generate an execution plan (rather than requesting the LLM generate the code itself at this stage). The execution plan may be in the form of an execution plan data structure that contains task nodes and edges, but, in contrast to the mind graph, it only describes one potential path through the task nodes. This essentially can be thought of as selecting one of the paths in the mind graph. FIG. 2 is an example execution plan 200, depicted in graphical form. Here, for example, the execution plan 200 indicates one path from mind graph 100A, specifically the path that goes from start node 130 to task node 102 to task node 104 to task node 106 to task node 108 to the end node 132.

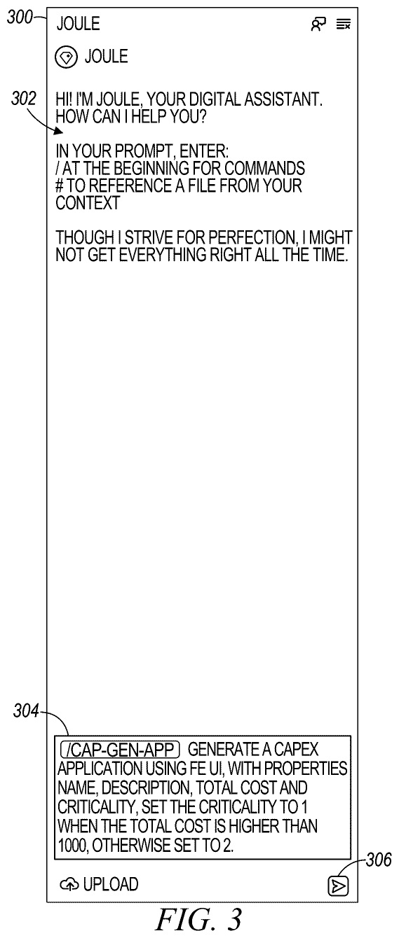

Once the generated executed plan is received from the LLM, it can be displayed to the user for approval and/or editing. FIGS. 3-5 are diagram illustrating an example graphical user interface 300 at different times during LLM generation, in accordance with an example embodiment.

Referring first to FIG. 3, here the graphical user interface 300 depicts instructions 302 provided to a user as to how to enter a natural language request, and a request box 304 where the user can enter the request. Here, the user has entered the request “/cap-gen-app. Generate a capex application using FE UI, with properties name, description, total cost, and criticality, set the criticality to 1 when the total cost is higher than 1000, otherwise set to 2.” This indicates the project within the request.

Once the user finishes the request, they may select a button 306 to send the request to the LLM. Behind the scenes, a prompt is formed using the request as well as a mind graph for the project. This may be, for example, a mind graph previously generated for the /cap-gen-app project, or may be one that is retrieved based on the type of the /cap-gen-app project. The prompt is then sent to the LLM, which generates an execution plan.

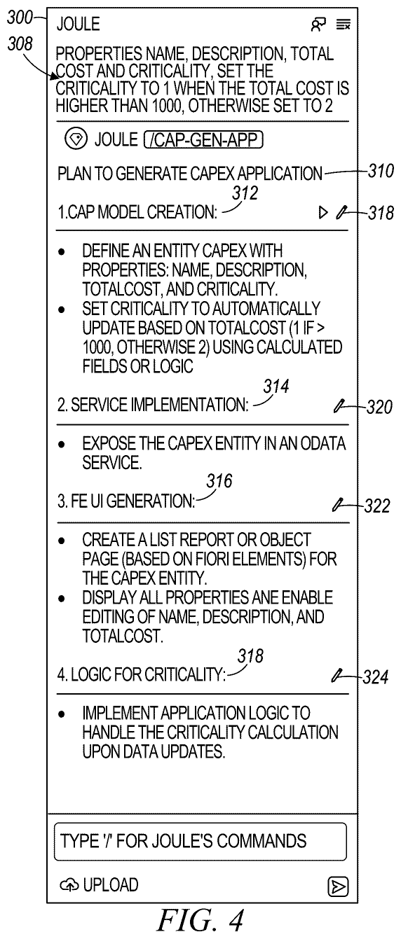

Referring to FIG. 4, here the graphical user interface 300 displays the execution plan 308 generated by the LLM. Notably, the execution plan 308 is broken into four parts 310, 312, 314, 316, one for each task node in the execution plan 308. Each part 310, 312, 314, 316 includes LLM-generated text indicating what the task will accomplish and how. An edit button 318, 320, 322, 324 is provided next to each part 310, 312, 314, 316. If the user selects one of the edit buttons 318, 320, 322, 324 they are then able to directly edit the corresponding LLM-generated text in the corresponding part 310, 312, 314, 316.

Once the editing, if any, is complete, the user can indicate that they are ready for the LLM to actually perform the tasks in the execution plan 308. These are performed one by one, with the user able to pause this generation process at any time and accept or reject generated code. Thus, if the user selects play button 318, this indicates they are ready for the first task to be executed.

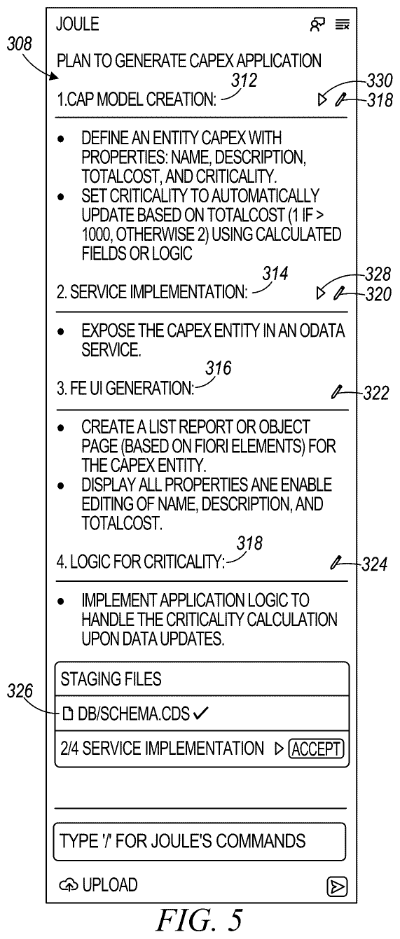

Referring to FIG. 5, herein the graphical user interface 300 displays the result of the generation performed in the first task. Specifically, a file named db/schedma.cds 326 has been generated. The user can review that file, and either proceed with selecting the play button 328 for the next task in the execution plan 308 or select the play button 330 to repeat the first task. This process continues through all of the tasks, at which point the user can accept or reject all the generated code.

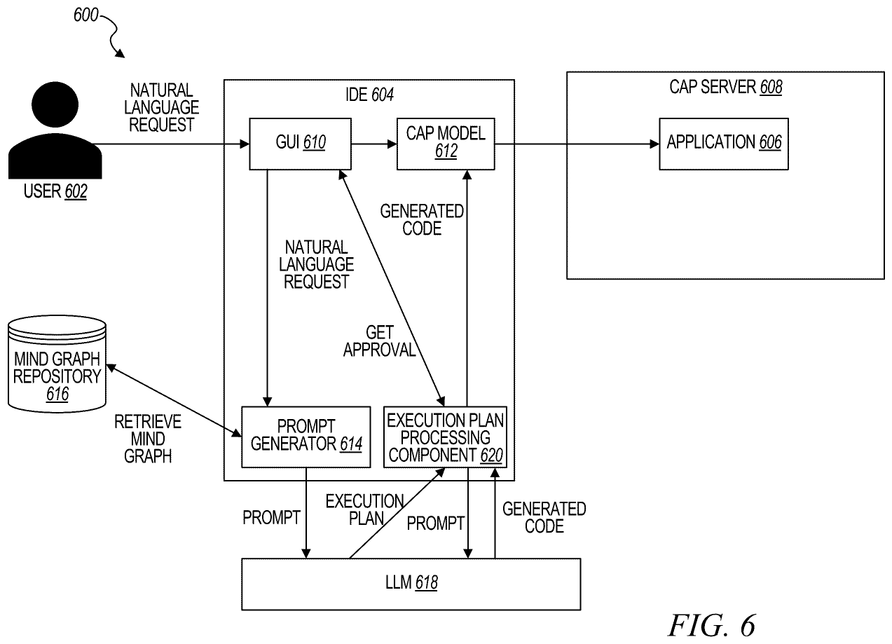

FIG. 6 is a block diagram illustrating a system 600 for mind graph-based code generation, in accordance with an example embodiment. Here, a user 602 interacts with an integrated development environment (IDE) 604 to develop an application 606 on a CAP server 608.

Within the IDE 604 is a graphical user interface 610 which the user 602 uses to enter a natural language request to generate a portion of a CAP model 612 that is used to create the application 606. The natural language request may contain an indication of a CAP project to create. Based on this indication, the prompt generator 614 retrieves a mind graph from a mind graph repository 616.

The prompt generator 614 then forms a prompt using the mind graph and the natural language request. In some example embodiments, this may also utilize retrieval augmented generation (RAG) techniques. RAG is a framework that combines traditional retrieval techniques with generative models to improve the quality of generated responses, particularly in tasks like question answering or conversational agents. In RAG, the process typically involves two main steps:
Retrieval: The system first retrieves relevant documents or pieces of information from a large database or knowledge base based on the input query. This can be performed using techniques like search algorithms or vector embeddings to find the most pertinent information.
Generation: After retrieving relevant information, a generative model (like an LLM) processes this data to produce a coherent and contextually appropriate response. The model can leverage the retrieved content to enhance its answers, making them more accurate and informative.

The combination allows the model to provide richer, more context-aware responses than it could generate from scratch, tapping into a larger body of knowledge while still being able to generate natural language responses. The responses may be based on specifically cohesive content.

Here, this means that context chunks may be stored in a vector store (not pictured), which may be accessed, possibly repeatedly, by the prompt generator 614 to enhance the generated prompt with additional context.

In the case of vector embeddings, a vector embedding is a set of coordinates in a latent n-dimensional space such that the proximity (e.g., cosine distance) of the coordinates to other coordinates is indicative of the similarity of the information embedded to those coordinates. In an example embodiment, the embedding is a high-dimensional (e.g., 1536-dimension) floating point vector, and the texts with similar semantics will have the corresponding similar embeddings.

Thus, in one example embodiment, vector embeddings may be combined with RAG to provide improved LLM generation. Specifically, an embedding machine learning model is trained on a large corpus of text and then used to perform the embedding of the underlying text into embeddings. This allows similar pieces of text to be identified even from text that is different. For example, text including the term “apartment” may be similar to text including the term “flat”, even though their words are completely different. Thus, the embeddings for these two words may be geometrically close to each other in the latent n-dimensional space.

The prompt may include a request for an LLM 618 to generate an execution plan for the corresponding mind graph. Once the prompt is finalized, the prompt generator 614 sends the generated prompt to the LLM 618 to generate the execution plan.

LLMs used to generate information are generally referred to as Generative Artificial Intelligence (GAI) models. A GAI model may be implemented as a generative pre-trained transformer (GPT) model or a bidirectional encoder. A GPT model is a type of machine learning model that uses a transformer architecture, which is a type of deep neural network that excels at processing sequential data, such as natural language.

A bidirectional encoder is a type of neural network architecture in which the input sequence is processed in two directions: forward and backward. The forward direction starts at the beginning of the sequence and processes the input one token at a time, while the backward direction starts at the end of the sequence and processes the input in reverse order.

By processing the input sequence in both directions, bidirectional encoders can capture more contextual information and dependencies between words, leading to better performance. The bidirectional encoder may be implemented as a Bidirectional Long Short-Term Memory (BiLSTM) or BERT (Bidirectional Encoder Representations from Transformers) model.

Each direction has its own hidden state, and the final output is a combination of the two hidden states.

Long Short-Term Memories (LSTMs) are a type of recurrent neural network (RNN) that are designed to overcome the vanishing gradient problem in traditional RNNs, which can make it difficult to learn long-term dependencies in sequential data.

LSTMs include a cell state, which serves as a memory that stores information over time. The cell state is controlled by three gates: the input gate, the forget gate, and the output gate. The input gate determines how much new information is added to the cell state, while the forget gate decides how much old information is discarded. The output gate determines how much of the cell state is used to compute the output. Each gate is controlled by a sigmoid activation function, which outputs a value between 0 and 1 that determines the amount of information that passes through the gate.

In BiLSTM, there is a separate LSTM for the forward direction and the backward direction. At each time step, the forward and backward LSTM cells receive the current input token and the hidden state from the previous time step. The forward LSTM processes the input tokens from left to right, while the backward LSTM processes them from right to left.

The output of each LSTM cell at each time step is a combination of the input token and the previous hidden state, which allows the model to capture both short-term and long-term dependencies between the input tokens.

BERT applies bidirectional training of a model known as a transformer to language modelling. This is in contrast to prior art solutions that looked at a text sequence either from left to right or combined left to right and right to left. A bidirectionally trained language model has a deeper sense of language context and flow than single-direction language models.

More specifically, the transformer encoder reads the entire sequence of information at once, and thus is considered to be bidirectional (although one could argue that it is, in reality, non-directional). This characteristic allows the model to learn the context of a piece of information based on all of its surroundings.

In other example embodiments, a generative adversarial network (GAN) embodiment may be used. GAN is a supervised machine learning model that has two sub-models: a generator model that is trained to generate new examples, and a discriminator model that tries to classify examples as either real or generated. The two models are trained together in an adversarial manner (using a zero-sum game according to game theory), until the discriminator model is fooled roughly half the time, which means that the generator model is generating plausible examples.

The generator model takes a fixed-length random vector as input and generates a sample in the domain in question. The vector is drawn randomly from a Gaussian distribution, and the vector is used to seed the generative process. After training, points in this multidimensional vector space will correspond to points in the problem domain, forming a compressed representation of the data distribution. This vector space is referred to as a latent space, or a vector space comprised of latent variables. Latent variables, or hidden variables, are those variables that are important for a domain but are not directly observable.

The discriminator model takes an example from the domain as input (real or generated) and predicts a binary class label of real or fake (generated).

Generative modeling is an unsupervised learning problem, although a clever property of the GAN architecture is that the training of the generative model is framed as a supervised learning problem.

The two models, the generator and discriminator, are trained together. The generator generates a batch of samples, and these, along with real examples from the domain, are provided to the discriminator and classified as real or fake.

The discriminator is then updated to get better at discriminating real and fake samples in the next round, and importantly, the generator is updated based on how well, or not, the generated samples fooled the discriminator.

In another example embodiment, the GAI model is a Variational AutoEncoders (VAEs) model. VAEs comprise an encoder network that compresses the input data into a lower-dimensional representation, called a latent code, and a decoder network that generates new data from the latent code. In either case, the GAI model contains a generative classifier, which can be implemented as, for example, a naïve Bayes classifier.

The LLM 618 returns the generated execution plan. This is received by an execution plan processing component 620, which then coordinates with the graphical user interface 610 to display the execution plan and allow the user to interact with a graphical representation of the graphical user interface 610 to cause the generation of portions of the CAP project. Specifically, here the graphical user interface 610 can implement screens similar to those described above with respect to FIGS. 3-5. At each iteration, the user may select a task for which code should be generated. The execution plan processing component 620 then generates a prompt to the LLM 618 to generate the code for that task. The execution plan processing component 620 then displays this generated code to the user via the graphical user interface 610, and then if the generated code is accepted by the user, moves on to the next task (assuming there are any additional tasks). Additionally, during this planning phase, corresponding domain knowledge may be used to apply or suggest best practices for the plan, using, for example, domain knowledge learned by the LLM and/or using RAG to retrieve domain-specific knowledge from a vector database.

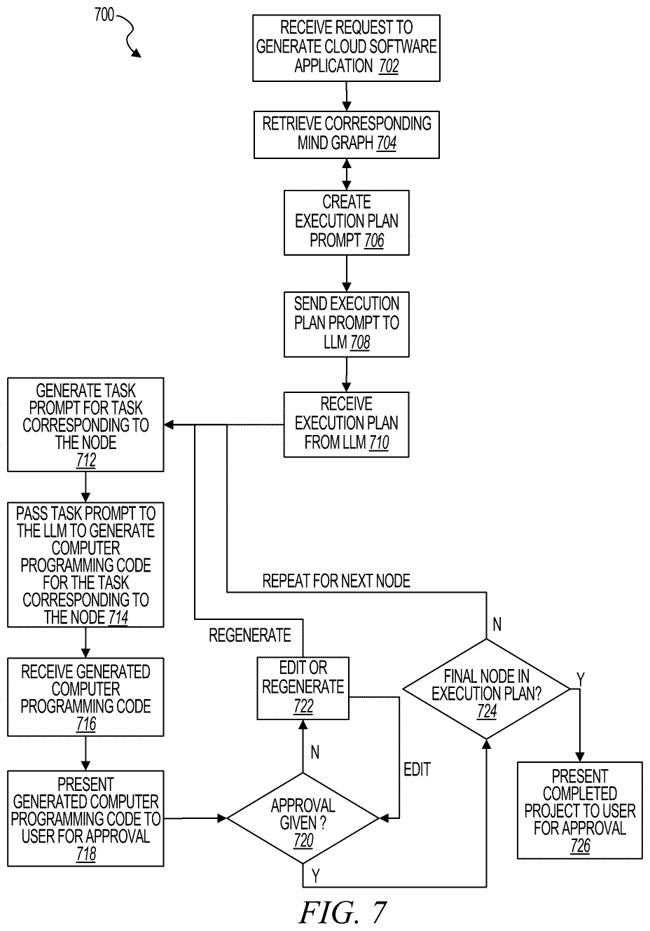

FIG. 7 is a flow diagram illustrating a method 700 for mind graph-based code generation, in accordance with an example embodiment.

At operation 702, a natural language request to generate a cloud software application is received at an IDE. At operation 704, a mind graph corresponding to the natural language request is retrieved. The mind graph comprises a plurality of nodes and a plurality of edges connecting the nodes, each node corresponding to a different task for generating the cloud software application, each edge defining a possible path of flow to generate the cloud software, such that the mind graph defines a plurality of different paths of nodes and edges.

At operation 706, an execution plan prompt is created based on the natural language request and the mind graph. At operation 708, the execution plan prompt is sent to an LLM to cause the LLM to generate an execution plan.

At operation 710, the execution plan is received from the LLM. The execution plan comprises a selection of one path of flow through one or more of the nodes of the mind graph. A loop is then begun for each node in the one or more nodes in the execution plan. At operation 712, a task prompt corresponding to a task associated with the corresponding node is generated. At operation 714, the task prompt is passed to the LLM to generate computer programming code for the task associated with the corresponding node. At operation 716, generated computer programming code for the task associated with the corresponding node is received from the LLM. At operation 718, the generated computer programming code is presented to a user for approval. At operation 720, it is determined if approval has been given. If not, then at operation 722, edits from the user may be received or the task's code could be regenerated by returning to operation 712. Once operation 720 determines that approval has been given, or if edits were at operation 722 it is determined at operation 724 if there are any more nodes in the execution plan. If so, then the method 700 loops back to operation 712 for the next node in the execution plan. If not, then at operation 726 the completed project is presented to the user for approval.

In view of the disclosure above, various examples are set forth below. It should be noted that one or more features of an example, taken in isolation or combination, should be considered within the disclosure of this application.

Example 1 is a system comprising: at least one hardware processor; and a computer-readable medium storing instructions that, when executed by the at least one hardware processor, cause the at least one hardware processor to perform operations comprising: receiving, at an integrated development environment, a natural language request to generate a cloud software application; retrieving a mind graph corresponding to the natural language request, the mind graph comprising a plurality of nodes and a plurality of edges connecting the nodes, each node corresponding to a different task for generating the cloud software application, each edge defining a possible path of flow to generate the cloud software, such that the mind graph defines a plurality of different paths of nodes and edges; generating an execution plan prompt based on the natural language request and the mind graph; sending the execution plan prompt to a large language model (LLM) to cause the LLM to generate an execution plan; receiving the execution plan from the LLM, the execution plan comprising a selection of one path of flow through one or more of the nodes of the mind graph; for each node in the one or more nodes in the execution plan: generating a task prompt corresponding to a task associated with the corresponding node; and passing the task prompt to the LLM to generate computer programming code for the task associated with the corresponding node.

In Example 2, the subject matter of Example 1 comprises, wherein the operations further comprise, for each node in the one or more nodes in the execution plan: receiving generated computer programming code for the task associated with the corresponding node; and obtaining approval from a user of the generated computer programming code prior to processing to generating a task prompt for a next node in the one or more nodes in the execution plan.

In Example 3, the subject matter of Examples 1-2 comprises, wherein the generating the execution plan prompt comprises using retrieval augmented generation.

In Example 4, the subject matter of Examples 1-3 comprises, wherein the cloud software application is based on a cloud application programming model.

In Example 5, the subject matter of Examples 2-4 comprises, wherein the obtaining approval is performed by providing information to the user via a graphical user interface regarding the generated computer programming code for the task and allow the user to edit the generated computer programming code or select a button indicating the generated computer programming code is approved to proceed to generating the task prompt for a subsequent node in the execution plan.

In Example 6, the subject matter of Example 5 comprises, wherein the graphical user interface is also used to receive the natural language request.

In Example 7, the subject matter of Examples 1-6 comprises, wherein the mind graph is predefined for a particular category of cloud software application.

Example 8 is a method comprising: receiving, at an integrated development environment, a natural language request to generate a cloud software application; retrieving a mind graph corresponding to the natural language request, the mind graph comprising a plurality of nodes and a plurality of edges connecting the nodes, each node corresponding to a different task for generating the cloud software application, each edge defining a possible path of flow to generate the cloud software, such that the mind graph defines a plurality of different paths of nodes and edges; generating an execution plan prompt based on the natural language request and the mind graph; sending the execution plan prompt to a large language model (LLM) to cause the LLM to generate an execution plan; receiving the execution plan from the LLM, the execution plan comprising a selection of one path of flow through one or more of the nodes of the mind graph; for each node in the one or more nodes in the execution plan: generating a task prompt corresponding to a task associated with the corresponding node; and passing the task prompt to the LLM to generate computer programming code for the task associated with the corresponding node.

In Example 9, the subject matter of Example 8 comprises, for each node in the one or more nodes in the execution plan: receiving generated computer programming code for the task associated with the corresponding node; and obtaining approval from a user of the generated computer programming code prior to processing to generating a task prompt for a next node in the one or more nodes in the execution plan.

In Example 10, the subject matter of Examples 8-9 comprises, wherein the generating the execution plan prompt comprises using retrieval augmented generation.

In Example 11, the subject matter of Examples 8-10 comprises, wherein the cloud software application is based on a cloud application programming model.

In Example 12, the subject matter of Examples 9-11 comprises, wherein the obtaining approval is performed by providing information to the user via a graphical user interface regarding the generated computer programming code for the task and allow the user to edit the generated computer programming code or select a button indicating the generated computer programming code is approved to proceed to generating the task prompt for a subsequent node in the execution plan.

In Example 13, the subject matter of Example 12 comprises, wherein the graphical user interface is also used to receive the natural language request.

In Example 14, the subject matter of Examples 8-13 comprises, wherein the mind graph is predefined for a particular category of cloud software application.

Example 15 is a non-transitory machine-readable medium storing instructions which, when executed by one or more processors, cause the one or more processors to perform operations comprising: receiving, at an integrated development environment, a natural language request to generate a cloud software application; retrieving a mind graph corresponding to the natural language request, the mind graph comprising a plurality of nodes and a plurality of edges connecting the nodes, each node corresponding to a different task for generating the cloud software application, each edge defining a possible path of flow to generate the cloud software, such that the mind graph defines a plurality of different paths of nodes and edges; generating an execution plan prompt based on the natural language request and the mind graph; sending the execution plan prompt to a large language model (LLM) to cause the LLM to generate an execution plan; receiving the execution plan from the LLM, the execution plan comprising a selection of one path of flow through one or more of the nodes of the mind graph; for each node in the one or more nodes in the execution plan: generating a task prompt corresponding to a task associated with the corresponding node; and passing the task prompt to the LLM to generate computer programming code for the task associated with the corresponding node.

In Example 16, the subject matter of Example 15 comprises, wherein the operations further comprise, for each node in the one or more nodes in the execution plan: receiving generated computer programming code for the task associated with the corresponding node; and obtaining approval from a user of the generated computer programming code prior to processing to generating a task prompt for a next node in the one or more nodes in the execution plan.

In Example 17, the subject matter of Examples 15-16 comprises, wherein the generating the execution plan prompt comprises using retrieval augmented generation.

In Example 18, the subject matter of Examples 15-17 comprises, wherein the cloud software application is based on a cloud application programming model.

In Example 19, the subject matter of Examples 16-18 comprises, wherein the obtaining approval is performed by providing information to the user via a graphical user interface regarding the generated computer programming code for the task and allow the user to edit the generated computer programming code or select a button indicating the generated computer programming code is approved to proceed to generating the task prompt for a subsequent node in the execution plan.

In Example 20, the subject matter of Example 19 comprises, wherein the graphical user interface is also used to receive the natural language request.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

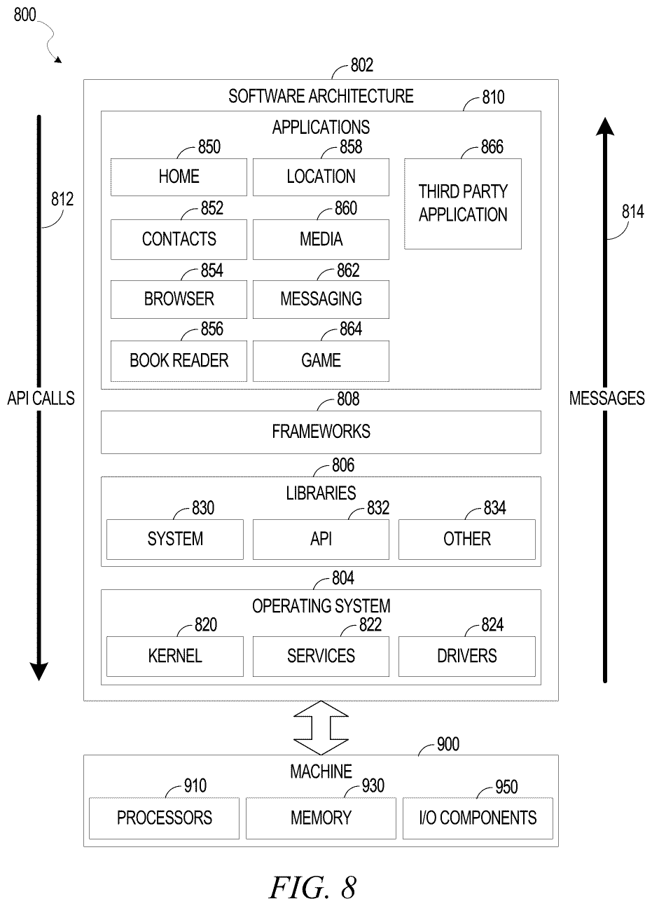

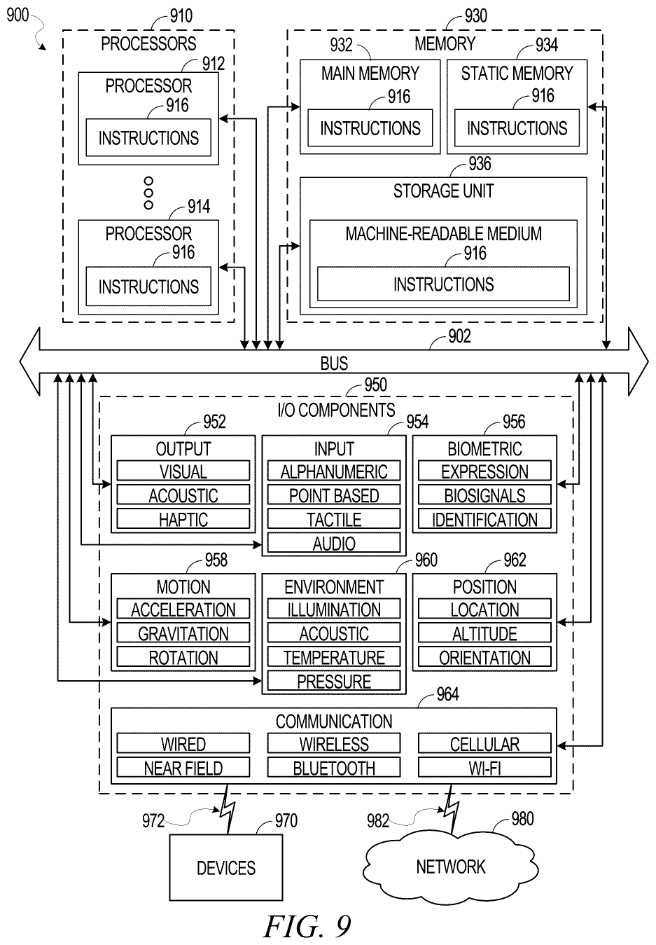

FIG. 8 is a block diagram 800 illustrating a software architecture 802, which can be installed on any one or more of the devices described above. FIG. 8 is merely a non-limiting example of a software architecture, and it will be appreciated that many other architectures can be implemented to facilitate the functionality described herein. In various embodiments, the software architecture 802 is implemented by hardware such as a machine 900 of FIG. 9 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionalities. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 806 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics [PNG]), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 808 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 and send messages 814 to facilitate functionality described herein.

FIG. 9 illustrates a diagrammatic representation of a machine 900 in the form of a computer system within which a set of instructions may be executed for causing the machine 900 to perform any one or more of the methodologies discussed herein, according to an example embodiment. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example, the instructions 916 may cause the machine 900 to execute the method 700 of FIG. 7. Additionally, or alternatively, the instructions 916 may implement FIGS. 1-7 and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions 916 contemporaneously. Although FIG. 9 shows multiple processors 910, the machine 900 may include a single processor 912 with a single core, a single processor 912 with multiple cores (e.g., a multi-core processor 912), multiple processors 912, 914 with a single core, multiple processors 912, 914 with multiple cores, or any combination thereof.

The memory 930 may include a main memory 932, a static memory 934, and a storage unit 936, each accessible to the processors 910 such as via the bus 902. The main memory 932, the static memory 934, and the storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion, and the grouping is in no way limiting. In various example embodiments, the I/O components 950 may include output components 952 and input components 954. The output components 952 may include visual components (e.g., a display such as a plasma display panel (PDP), a light-emitting diode (LED) display, a liquid crystal display (LCD), a projector, or a cathode ray tube [CRT]), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 962 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., coupled via a USB).

Moreover, the communication components 964 may detect identifiers or include components operable to detect identifiers. For example, the communication components 964 may include radio-frequency identification (RFID) tag reader components, NFC smart tag detection components, optical reader components (e.g., an optical sensor to detect one-dimensional bar codes such as Universal Product Code (UPC) bar code, multi-dimensional bar codes such as QR code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 964, such as location via Internet Protocol (IP) geolocation, location via Wi-Fi® signal triangulation, location via detecting an NFC beacon signal that may indicate a particular location, and so forth.

The various memories (e.g., 930, 932, 934, and/or memory of the processor(s) 910) and/or the storage unit 936 may store one or more sets of instructions 916 and data structures (e.g., software) embodying or utilized by any one or more of the methodologies or functions described herein. These instructions (e.g., the instructions 916), when executed by the processor(s) 910, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 980 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 970. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
receiving, at an integrated development environment, a natural language request to generate a cloud software application;
retrieving a mind graph corresponding to the natural language request, the mind graph comprising a plurality of nodes and a plurality of edges connecting the nodes, each node corresponding to a different task for generating the cloud software application, each edge defining a possible path of flow to generate the cloud software, such that the mind graph defines a plurality of different paths of nodes and edges;
generating an execution plan prompt based on the natural language request and the mind graph;
sending the execution plan prompt to a large language model (LLM) to cause the LLM to generate an execution plan;
receiving the execution plan from the LLM, the execution plan comprising a selection of one path of flow through one or more of the nodes of the mind graph;
for each node in the one or more nodes in the execution plan:
generating a task prompt corresponding to a task associated with the corresponding node; and
passing the task prompt to the LLM to generate computer programming code for the task associated with the corresponding node.

2. The system of claim 1, wherein the operations further comprise, for each node in the one or more nodes in the execution plan:
receiving generated computer programming code for the task associated with the corresponding node; and
obtaining approval from a user of the generated computer programming code prior to processing to generating a task prompt for a next node in the one or more nodes in the execution plan.

3. The system of claim 1, wherein the generating the execution plan prompt comprises using retrieval augmented generation.

4. The system of claim 1, wherein the cloud software application is based on a cloud application programming model.

5. The system of claim 2, wherein the obtaining approval is performed by providing information to the user via a graphical user interface regarding the generated computer programming code for the task and allow the user to edit the generated computer programming code or select a button indicating the generated computer programming code is approved to proceed to generating the task prompt for a subsequent node in the execution plan.

6. The system of claim 5, wherein the graphical user interface is also used to receive the natural language request.

7. The system of claim 1, wherein the mind graph is predefined for a particular category of cloud software application.

8. A method comprising:
receiving, at an integrated development environment, a natural language request to generate a cloud software application;
retrieving a mind graph corresponding to the natural language request, the mind graph comprising a plurality of nodes and a plurality of edges connecting the nodes, each node corresponding to a different task for generating the cloud software application, each edge defining a possible path of flow to generate the cloud software, such that the mind graph defines a plurality of different paths of nodes and edges;
generating an execution plan prompt based on the natural language request and the mind graph;
sending the execution plan prompt to a large language model (LLM) to cause the LLM to generate an execution plan;
receiving the execution plan from the LLM, the execution plan comprising a selection of one path of flow through one or more of the nodes of the mind graph;
for each node in the one or more nodes in the execution plan:
generating a task prompt corresponding to a task associated with the corresponding node; and
passing the task prompt to the LLM to generate computer programming code for the task associated with the corresponding node.

9. The method of claim 8, further comprising, for each node in the one or more nodes in the execution plan:
receiving generated computer programming code for the task associated with the corresponding node; and
obtaining approval from a user of the generated computer programming code prior to processing to generating a task prompt for a next node in the one or more nodes in the execution plan.

10. The method of claim 8, wherein the generating the execution plan prompt comprises using retrieval augmented generation.

11. The method of claim 8, wherein the cloud software application is based on a cloud application programming model.

12. The method of claim 9, wherein the obtaining approval is performed by providing information to the user via a graphical user interface regarding the generated computer programming code for the task and allow the user to edit the generated computer programming code or select a button indicating the generated computer programming code is approved to proceed to generating the task prompt for a subsequent node in the execution plan.

13. The method of claim 12, wherein the graphical user interface is also used to receive the natural language request.

14. The method of claim 8, wherein the mind graph is predefined for a particular category of cloud software application.

15. A non-transitory machine-readable medium storing instructions which, when executed by one or more processors, cause the one or more processors to perform operations comprising:
receiving, at an integrated development environment, a natural language request to generate a cloud software application;
retrieving a mind graph corresponding to the natural language request, the mind graph comprising a plurality of nodes and a plurality of edges connecting the nodes, each node corresponding to a different task for generating the cloud software application, each edge defining a possible path of flow to generate the cloud software, such that the mind graph defines a plurality of different paths of nodes and edges;
generating an execution plan prompt based on the natural language request and the mind graph;
sending the execution plan prompt to a large language model (LLM) to cause the LLM to generate an execution plan;
receiving the execution plan from the LLM, the execution plan comprising a selection of one path of flow through one or more of the nodes of the mind graph;
for each node in the one or more nodes in the execution plan:
generating a task prompt corresponding to a task associated with the corresponding node; and
passing the task prompt to the LLM to generate computer programming code for the task associated with the corresponding node.

16. The non-transitory machine-readable medium of claim 15, wherein the operations further comprise, for each node in the one or more nodes in the execution plan:
receiving generated computer programming code for the task associated with the corresponding node; and
obtaining approval from a user of the generated computer programming code prior to processing to generating a task prompt for a next node in the one or more nodes in the execution plan.

17. The non-transitory machine-readable medium of claim 15, wherein the generating the execution plan prompt comprises using retrieval augmented generation.

18. The non-transitory machine-readable medium of claim 15, wherein the cloud software application is based on a cloud application programming model.

19. The non-transitory machine-readable medium of claim 16, wherein the obtaining approval is performed by providing information to the user via a graphical user interface regarding the generated computer programming code for the task and allow the user to edit the generated computer programming code or select a button indicating the generated computer programming code is approved to proceed to generating the task prompt for a subsequent node in the execution plan.

20. The non-transitory machine-readable medium of claim 19, wherein the graphical user interface is also used to receive the natural language request.
